(19) United States
(12) Patent Application Publication
(10) Pub. No.: US 2022/0195160 A1
(43) Pub. Date: Jun. 23, 2022

(54) POLYETHYLENE COPOLYMERS AND TERPOLYMERS FOR SHOES AND METHODS THEREOF

(71) Applicant: Braskem S.A., Camaçari (BR)

(72) Inventors: Murilo Lauer Sanson, Sao Paulo City (BR); Hadi Mohammadi, Philadelphia, PA (US); Juliani Cappra Da Silva, Sao Paulo City (BR); Nei Sebastião Domingues Junior, Sao Paulo City (BR)

(73) Assignee: Braskem S.A., Camaçari (BR)

(21) Appl. No.: 17/556,411

(22) Filed: Dec. 20, 2021

Related U.S. Application Data
(60) Provisional application No. 63/222,260, filed on Jul. 15, 2021.
(60) Provisional application No. 63/127,764, filed on Dec. 18, 2020.

(51) Int. Cl. C08L 23/08; C08K 5/14; C08K 5/23; C08K 5/103; C08K 3/26; C08K 3/22; C08J 9/16; C08J 9/10; C08J 9/12; A43B 13/04

(52) U.S. Cl. CPC C08L 23/0869; C08L 23/0853; C08K 5/14; C08K 5/23; C08K 5/103; C08K 3/26; C08K 2003/2296; C08J 9/16; C08J 9/105; C08J 9/127; A43B 13/04; C08L 2203/30; C08K 2003/265; C08K 3/22

(57) ABSTRACT

A polymer composition that includes a polymer produced from ethylene, one or more branched vinyl ester monomers, and optionally, vinyl acetate; optionally a secondary foamable polymer; a foaming agent, and a peroxide is provided. Methods for making such a polymer composition include blending a polymer composition from a mixture of a polymer produced from ethylene, one or more branched vinyl ester monomers, and optionally, vinyl acetate, optionally a secondary foamable polymer; a foaming agent, and a peroxide are provided.

### BACKGROUND

Polyolefin copolymers such as ethylene vinyl acetate (EVA) may be used to manufacture a varied range of articles, including films, molded products, foams, and the like. In general, polyolefins are widely used plastics worldwide, given their versatility in a wide range of applications. EVA may have characteristics such as high processability, low production cost, flexibility, low density and recycling possibility. However, EVA compositions generally do not have a combination of density and hardness that enables their use in the production of articles that are required to have a very soft touch.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polymer composition that includes a polymer produced from ethylene, one or more branched vinyl ester monomers, and optionally, vinyl acetate; a foaming agent; and a peroxide.

In one aspect, embodiments disclosed herein relate to an expanded article prepared from a polymer composition that includes a polymer produced from ethylene, one or more branched vinyl ester monomers, and optionally, vinyl acetate; a foaming agent; and a peroxide.

In another aspect, embodiments disclosed herein relate to a method that includes blending a polymer composition from a mixture, wherein the mixture includes a polymer produced from ethylene, one or more branched vinyl ester monomers, and optionally, vinyl acetate; optionally a secondary foamable polymer; a foaming agent; and a peroxide.

Other aspects and advantages of the claimed subject matter will be apparent from the following description and the appended claims.

### BRIEF DESCRIPTION OF DRAWINGS

FIG. 1 shows a scanning electron microscope of sample 1 (left: magnification of 200×, right: magnification of 500×).

FIG. 2 shows a scanning electron microscope of sample 2 (left: magnification of 200×, right: magnification of 500×).

FIG. 3 shows a scanning electron microscope of sample 3 (left: magnification of 200×, right: magnification of 500×).

FIG. 4 shows a scanning electron microscope of sample 4 (left: magnification of 200×, right: magnification of 500×).

FIG. 5 shows a scanning electron microscope of sample 1 (left: magnification of 200×, right: magnification of 500×).

FIG. 6 shows a scanning electron microscope of sample 2 (left: magnification of 200×, right: magnification of 500×).

FIG. 7 shows a scanning electron microscope of sample 3 (left: magnification of 200×, right: magnification of 500×).

FIG. 8 shows a scanning electron microscope of sample 4 (left: magnification of 200×, right: magnification of 500×).

FIG. 9 shows a scanning electron microscope of sample 8 (left: magnification of 200×, right: magnification of 500×).

FIG. 10 shows a scanning electron microscope of sample 12 (left: magnification of 200×, right: magnification of 500×).

### DETAILED DESCRIPTION

In one aspect, embodiments disclosed herein relate to polymer compositions containing copolymers prepared from ethylene and one or more branched vinyl ester monomers, and terpolymers prepared from ethylene, a branched vinyl ester and vinyl acetate. In one or more embodiments, polymer compositions may be expanded to produce articles having a good combination of properties, such as low hardness and density with good resilience and compression. Such polymer compositions may be useful in a variety of applications including footwear.

Polymer compositions in accordance with the present disclosure may include copolymers incorporating various ratios of ethylene and one or more branched vinyl esters. In some embodiments, polymer compositions may be prepared by reacting ethylene and a branched vinyl ester in the presence of additional comonomers in a high-pressure polymerization process. In other embodiments, terpolymers may be similarly prepared by additionally incorporating a vinyl acetate monomer. In one or more embodiments, the polymer compositions may include polymers generated from monomers derived from petroleum and/or renewable sources.

Polymer Compositions

In one or more embodiments, polymer compositions disclosed herein include a suitable amount of a polymer produced from ethylene, one or more branched vinyl ester monomers, and optionally, vinyl acetate. In some embodiments, polymer compositions include 50 to 100 phr (parts per hundred resin) of a polymer produced from ethylene, one or more branched vinyl ester monomers, and optionally, vinyl acetate. The polymer produced from ethylene, one or more branched vinyl ester monomers, and optionally, vinyl acetate may have a lower limit of one of 50, 55, 60, 65, 70 or 75 phr and an upper limit of 80, 85, 90, 95 and 100 phr, where any lower limit may be combined with any mathematically compatible upper limit.

Polymer compositions disclosed herein may include a foaming agent in an amount ranging from a lower limit of one of 0.1 phr, 0.5 phr, 1 phr, 2 phr, 3 phr, 4 phr, 5 phr, 6 phr, 7 phr, 8 phr, or 9 phr and an upper limit of one of 10 phr, 11 phr, 12 phr, 13 phr, 14 phr or 15 phr where any lower limit may be combined with any mathematically compatible upper limit.

Polymer compositions disclosed herein may include a peroxide in an amount ranging from a lower limit of one of 0.1 phr, 0.4 phr, 1 phr, 1.6 phr, 2.2 phr, or 2.8 phr and an upper limit of one of 3.4 phr, 4 phr, 4.6 phr, 5.2 phr, 6 phr or 10 phr, where any lower limit may be combined with any mathematically compatible upper limit.

Polymer compositions disclosed herein may optionally include a foaming agent accelerator in an amount ranging from a lower limit of one of 0.1 phr, 0.2 phr, 0.5 phr, 1.0 phr, 1.5 phr, 2.0 phr, or 2.5 phr and an upper limit of one of 3.0 phr, 3.5 phr, 4.0 phr, 4.5 phr, or 5.0 phr where any lower limit may be combined with any mathematically compatible upper limit.

Polymer compositions in accordance with the present disclosure may optionally include a secondary foamable polymer in an amount ranging from 0.1 to 80 phr. The content of the secondary foamable polymer ranges from a lower limit selected from one of 0.1 phr, 1 phr, 5 phr, 10 phr, 20 phr, or 30 phr to an upper limit selected from 50 phr, 60 phr, 65 phr, 70 phr, 75 phr, or 80 phr, where any lower limit may be paired with any upper limit.

Polymer compositions disclosed herein may optionally include at least one filler or nanofiller in an amount ranging from a lower limit of one of 0.01 phr, 0.1 phr, 0.5 phr, 1.0 phr, 2.0 phr, or 5 phr, 10 phr, 15, prh, 20 prh and 25 phr and an upper limit of one of 35 phr, 40 phr, 45 phr, 50 phr, 55 phr, 60 phr, 65 phr, 70 phr or 75 phr, where any lower limit may be combined with any mathematically compatible upper limit.

Polymer compositions in accordance with the present disclosure may optionally include crosslinking co-agents, in a range from 0 to 10 phr. The crosslinking coagent may be present in an amount ranging from a lower limit of one of 0 phr, 0.5 phr, 1.0 phr, 1.5 phr, 2.0 phr, 3.0 phr, 4.0 phr, and 5.0 phr, and an upper limit of one of 6.0 phr, 7.0 phr, 8.0 phr, 8.5 phr, 9.0 phr, 9.5 phr, 10.0 phr, where any lower limit may be combined with any mathematically compatible upper limit.

Polymer compositions in accordance with the present disclosure may optionally include other elastomers, in a range from 0 to 60 phr. The elastomer may be present in an amount ranging from a lower limit of one of 0 phr, 5 phr, 10 phr, 15 phr, 20 phr, 25 phr, and 30 phr, and an upper limit of one of 35 phr, 40 phr, 45 phr, 50 phr, 55 phr, and 60 phr, where any lower limit may be combined with any mathematically compatible upper limit.

Polymer compositions in accordance with the present disclosure may optionally include plasticizers in an amount ranging from 0 to 20 phr. The plasticizer may be present in an amount ranging from a lower limit of one of 0 phr, 1.0 phr, 2.0 phr, and 5.0 phr, 8.0 phr and 10.0 phr, and an upper limit of one of 12 phr, 15 phr, 18 phr, 19 phr, and 20 phr where any lower limit may be combined with any mathematically compatible upper limit.

Polymer compositions in accordance with the present disclosure may optionally include waxes in an amount ranging from 0 to 20 phr. The wax may be present in an amount ranging from a lower limit of one of 0 phr, 1.0 phr, 2.0 phr, and 5.0 phr, 8.0 phr and 10.0 phr, and an upper limit of one of 12 phr, 15 phr, 18 phr, 19 phr, and 20 phr where any lower limit may be combined with any mathematically compatible upper limit.

Polymer compositions in accordance with the present disclosure may optionally include abrasion resistance additives, such as polysiloxanes, including poly(dimethylsiloxane) (PDMS), in a range from 0 to 20 phr. The abrasion resistance additive may be present in an amount ranging from a lower limit of one of 0 phr, 1.0 phr, 2.0 phr, and 5.0 phr, 8.0 phr and 10.0 phr, and an upper limit of one of 12 phr, 15 phr, 18 phr, 19 phr, and 20 phr where any lower limit may be combined with any mathematically compatible upper limit.

Branched Vinyl Ester Monomers and Polymers Produced Thereof

As mentioned above, the polymer compositions may include a co- or ter-polymer that includes a branched vinyl ester monomer. In one or more embodiments, branched vinyl esters may include branched vinyl esters generated from isomeric mixtures of branched alkyl acids. Branched vinyl esters in accordance with the present disclosure may have the general chemical formula (I):

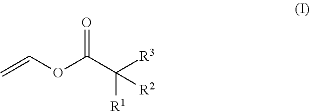

where R¹, R², and R³ have a combined carbon number in the range of C3 to C20. In some embodiments, le, R², and R³ may all be alkyl chains having varying degrees of branching in some embodiments, or a subset of R¹, R², and R³ may be independently selected from a group consisting of hydrogen, alkyl, or aryl in some embodiments.

In one or more embodiments, the branched vinyl esters may have the general chemical formula (II):

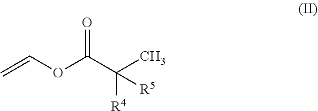

wherein R⁴ and R⁵ have a combined carbon number of 6 or 7 and the polymer composition has a number average molecular weight (Mₙ) ranging from 5 kDa to 10000 kDa obtained by GPC. In one or more embodiments, R⁴ and R⁵ may have a combined carbon number of less than 6 or greater than 7, and the polymer composition may have an Mₙ up to 10000 kDa. That is, when the Mₙ is less than 5 kDa, R⁴ and R⁵ may have a combined carbon number of less than 6 or greater than 7, but if the Mₙ is greater than 5 kDa, such as in a range from 5 to 10000 kDa, R⁴ and R⁵ may include a combined carbon number of 6 or 7. In particular embodiments, R⁴ and R⁵ have a combined carbon number of 7, and the Mₙ may range from 5 to 10000 kDa. Further in one or more particular embodiments, a vinyl carbonyl according to Formula (II) may be used in combination with vinyl acetate.

Examples of branched vinyl esters may include monomers having the chemical structures, including derivatives thereof:

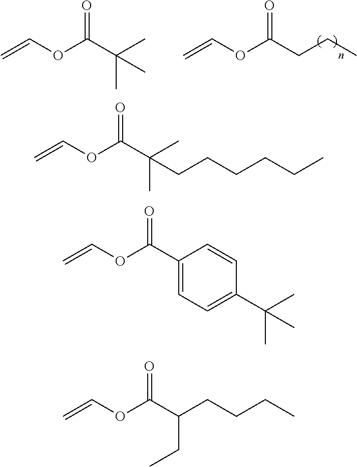

In one or more embodiments, the polymer compositions may include polymers generated from monomers derived from petroleum and/or renewable sources.

In one or more embodiments, branched vinyl esters may include monomers and comonomer mixtures containing vinyl esters of neononanoic acid, neodecanoic acid, and the like. In some embodiments, branched vinyl esters may include Versatic™ acid series tertiary carboxylic acids, including Versatic™ acid EH, Versatic™ acid 9 and Versatic™ acid 10 prepared by Koch synthesis, commercially available from Hexion™ chemicals.

Co- or ter-polymers that include a branched vinyl ester monomer in accordance with the present disclosure may include a percent by weight of ethylene measured by proton nuclear magnetic resonance (¹H NMR) and Carbon 13 nuclear magnetic resonance (¹³C NMR) that ranges from a lower limit selected from one of 70 wt %, 75 wt %, and 80 wt %, to an upper limit selected from one of 85 wt %, 90 wt %, 95 wt %, 99.9 wt %, and 99.99 wt % where any lower limit may be paired with any upper limit.

Co- or ter-polymers that include a branched vinyl ester monomer in accordance with the present disclosure may include a percent by weight of vinyl ester monomer, such as that of Formula (I) and (II) above, measured by ¹H NMR and ¹³C NMR that ranges from a lower limit selected from one of 0.01 wt %, 0.1 wt %, 1 wt %, 5 wt %, 10 wt %, 20 wt %, or 30 wt % to an upper limit selected from 50 wt %, 60 wt %, 70 wt %, 80 wt %, 89.99 wt %, or 90 wt % where any lower limit may be paired with any upper limit.

In some embodiments, co- or ter-polymers that include a branched vinyl ester monomer in accordance with the present disclosure may optionally include a percent by weight of vinyl acetate measured by ¹H NMR and ¹³C NMR that ranges from a lower limit selected from one of 0.01 wt %, 0.1 wt %, 1 wt %, 5 wt %, 10 wt %, 20 wt %, or 30 wt % to an upper limit selected from 50 wt %, 60 wt %, 70 wt %, 80 wt %, or 89.99 wt % where any lower limit may be paired with any upper limit. For the polymer samples containing the vinyl acetate and vinyl ester monomers, incorporation was determined using quantitative ¹³C NMR, since the ¹H NMR contained significant overlap in both the carbonyl and alkyl regions for accurate integration. Evidence of incorporation of the branched vinyl ester and vinyl acetate is seen in both the carbonyl (170-180 ppm) and alkyl regions (0-50 ppm) of the ¹³C NMR spectra (TCE-D₂, 393.1 K, 125 MHz). ¹H NMR spectra (TCE-D₂, 393.2 K, 500 MHz) exhibit peaks for vinyl acetate and branched vinyl ester (4.7-5.2 ppm) and ethylene (1.2-1.5 ppm) as well as additional peaks in the alkyl region (0.5-1.5 ppm) indicative of the long alkyl chains on the branched vinyl ester monomers. Relative intensity of the peaks found in ¹H NMR and ¹³C NMR spectra are used to calculate monomer incorporation of branched vinyl ester and vinyl acetate in the co-/terpolymers.

Co- or ter-polymers that include a branched vinyl ester monomer in accordance with the present disclosure may have a number average molecular weight (Mₙ) in kilodaltons (kDa) measured by gel permeation chromatography (GPC) that ranges from a lower limit selected from one of 1 kDa, 5 kDa, 10 kDa, 15 kDa, and 20 kDa to an upper limit selected from one of 40 kDa, 50 kDa, 100 kDa, 300 kDa, 500 kDa, 1000 kDa, 5000 kDa, and 10000 kDa, where any lower limit may be paired with any upper limit.

Co- or ter-polymers that include a branched vinyl ester monomer in accordance with the present disclosure may have a weight average molecular weight (M_{w}) in kilodaltons (kDa) measured by GPC that ranges from a lower limit selected from one of 1 kDa, 5 kDa, 10 kDa, 15 kDa and 20 kDa to an upper limit selected from one of 40 kDa, 50 kDa, 100 kDa, 200 kDa, 300 kDa, 500 kDa, 1000 kDa, 2000 kDa, 5000 kDa, 10000 kDa, and 20000 kDa, where any lower limit may be paired with any upper limit.

Co- or ter-polymers that include a branched vinyl ester monomer in accordance with the present disclosure may have a molecular weight distribution (MWD, defined as the ratio of M_{w} over Mₙ) measured by GPC that has a lower limit of any of 1, 2, 5, or 10, and an upper limit of any of 20, 30, 40, 50, or 60, where any lower limit may be paired with any upper limit.

The GPC analysis may be carried out in a gel permeation chromatography coupled with triple detection, with an infrared detector IRS and a four bridge capillary viscometer, both from PolymerChar and an eight angle light scattering detector from Wyatt. A set of 4 column, mixed bed, 13 μm from Tosoh in a temperature of 140° C. may be used. The experiments may be carried out in the following conditions: concentration of 1 mg/mL, flow rate of 1 mL/min, dissolution temperature and time of 160° C. and 90 minutes, respectively and an injection volume of 200 μL. The solvent used was TCB (Trichloro benzene) stabilized with 100 ppm of BHT.

In one or more embodiments, co- or ter-polymers that includes a branched vinyl ester monomer in accordance with the present disclosure may be prepared in reactor by polymerizing ethylene and one or more branched vinyl ester monomers, and optionally a vinyl acetate comonomer, as described for example in U.S. Patent Publication No. 2021/0102014, which is herein incorporated by reference in its entirety. Methods of reacting the comonomers in the presence of a radical initiator may include any suitable method in the art including solution phase polymerization, pressurized radical polymerization, bulk polymerization, emulsion polymerization, and suspension polymerization. In some embodiments, the reactor may be a batch autoclave reactor at temperatures below 150° C. and pressures below 500 bar, known as low pressure polymerization system. In some embodiments, the comonomers and one or more free-radical polymerization initiators are polymerized in a continuous or batch process at temperatures above 150° C. and at pressures above 1500 bar, known as high pressure polymerization systems. Copolymers and terpolymers produced under high pressure conditions may have number average molecular weights of 5 to 40 kDa, weight average molecular weights of 5 to 400 kDa and MWDs of 2 to 10.

In one or more embodiments, the reaction is carried out in a low pressure polymerization process wherein the ethylene and one or more branched vinyl ester monomers, and optionally a vinyl acetate comonomer are polymerized in a liquid phase of an inert solvent and/or one or more liquid monomer(s). In one embodiment, polymerization comprises initiators for free-radical polymerization in an amount from about 0.001 to about 0.01 milimoles calculated as the total amount of one or more initiator for free-radical polymerization per liter of the volume of the polymerization zone. The amount of ethylene in the polymerization zone will depend mainly on the total pressure of the reactor in a range from about 20 bar to about 100 bar and temperature in a range from about 20° C. to about 125° C. The liquid phase of the polymerization process in accordance with the present disclosure may include ethylene, one or more branched vinyl ester monomers, and optionally a vinyl acetate comonomer, initiator for free-radical polymerization, and optionally one or more inert solvent such as tetrahydrofuran (THF), chloroform, dichloromethane (DCM), dimethyl sulfoxide (DMSO), dimethyl carbonate (DMC), hexane, cyclohexane, ethyl acetate (EtOAc) acetonitrile, toluene, xylene, ether, dioxane, dimethyl-formamide (DMF), benzene or acetone. Copolymers and terpolymers produced under low-pressure conditions may exhibit number average molecular weights of 2 to 20 kDa, weight average molecular weights of 4 to 100 kDa and MWDs of 2 to 5.

Secondary Foamable Polymer

As previously described, polymers in accordance with one or more embodiments may optionally include a secondary foamable polymer.

The secondary foamable polymer may include different types of polyolefin polymers in particular embodiments. In one or more embodiments, the secondary foamable polymers may be selected from polyolefins, ethylene-based polymers (different from the co- or ter-polymers that include ethylene and a branched vinyl ester monomer), propylene-based polymers, and combinations thereof. In one or more embodiments, the secondary foamable polymer may be selected from the group consisting of low density polyethylene, high density polyethylene, linear low density polyethylene, copolymers of ethylene and one or more C3-C20 alpha olefins, polypropylene, ethylene vinyl acetate copolymer, ethylene methyl acrylate copolymer, ethylene butyl acrylate copolymer, ethylene-propylene copolymers, ethylene-propylene diene copolymer, thermoplastic ethylene elastomers, metallocene polymers, polyether block amide copolymers, polyvinylidene fluoride, chlorinated derivatives thereof, and combinations thereof.

In particular embodiments, the secondary foamable polymer is an ethylene vinyl acetate copolymer that may include a percent by weight of vinyl acetate measured by 41 NMR and ¹³C NMR that ranges from a lower limit selected from one of 0.01 wt %, 0.1 wt %, 1 wt %, 5 wt %, 10 wt %, or 15 wt % to an upper limit selected from 20 wt %, 25 wt %, 30 wt %, 35 wt %, 40 wt %, or 50 wt %, where any lower limit may be paired with any upper limit.

Peroxide

Polymer compositions in accordance with the present disclosure may include one or more peroxides capable of generating free radicals during polymer processing. In one or more embodiments, peroxide agents may include bifunctional peroxides such as benzoyl peroxide; dicumyl peroxide; di-tert-butyl peroxide; 00-Tert-amyl-0-2-ethylhexyl monoperoxycarbonate; tert-butyl cumyl peroxide; tert-butyl 3,5,5-trimethylhexanoate peroxide; tert-butyl peroxybenzoate; 2-ethylhexyl carbonate tert-butyl peroxide; 2,5-dimethyl-2,5-di(tert-butylperoxide) hexane; 1,1-di(tert-butylperoxide)-3,3,5-trimethylcyclohexane; 2,5-dimethyl-2,5-di(tert-butylperoxide) hexyne-3; 3,3,5,7,7-pentamethyl-1,2,4-trioxepane; butyl 4,4-di(tert-butylperoxide) valerate; di(2,4-dichlorobenzoyl) peroxide; di(4-methylbenzoyl) peroxide; peroxide di(tert-butylperoxyisopropyl) benzene; and the like.

Perooxides may also include benzoyl peroxide, 2,5-di(cumylperoxy)-2,5-dimethyl hexane, 2,5-di(cumylperoxy)-2,5-dimethyl hexyne-3,4-methyl-4-(t-butylperoxy)-2-pentanol, butyl-peroxy-2-ethyl-hexanoate, tert-butyl peroxypivalate, tertiary butyl peroxyneodecanoate, t-butyl-peroxy-benzoate, t-butyl-peroxy-2-ethyl-hexanoate, 4-methyl-4-(t-amylperoxy)-2-pentanol,4-methyl-4-(cumylperoxy)-2-pentanol, 4-methyl-4-(t-butylperoxy)-2-pentanone, 4-methyl-4-(t-amylperoxy)-2-pentanone, 4-methyl-4-(cumylperoxy)-2-pentanone, 2,5-dimethyl-2,5-di(t-butylperoxy)hexane, 2,5-dimethyl-2,5-di(t-amylperoxy)hexane, 2,5-dimethyl-2,5-di(t-butylperoxy)hexyne-3,2,5-dimethyl-2,5-di(t-amylperoxy)hexyne-3,2,5-dimethyl-2-t-butylperoxy-5-hydroperoxyhexane, 2,5-dimethyl-2-cumylperoxy-5-hydroperoxyhexane, 2,5-dimethyl-2-t-amylperoxy-5-hydroperoxyhexane, m/p-alpha, alpha-di[(t-butylperoxy)isopropyl]benzene, 1,3,5-tris(t-butylperoxyisopropyl)benzene, 1,3,5-tris(t-amylperoxyisopropyl)benzene, 1,3,5-tris(cumylperoxyisopropyl)benzene, di[1,3-dimethyl-3-(t-butylperoxy)butyl]carbonate, di[1,3-dimethyl-3-(t-amylperoxy)butyl]carbonate, di[1,3-dimethyl-3-(cumylperoxy)butyl]carbonate, di-t-amyl peroxide, t-amyl cumyl peroxide, t-butyl-isopropenylcumyl peroxide, 2,4,6-tri (butylperoxy)-s-triazine, 1,3,5-tri[1-(t-butylperoxy)-1-methylethyl]benzene, 1,3,5-tri-[(t-butylperoxy)-isopropyl]benzene, 1,3-dimethyl-3-(t-butylperoxy)butanol, 1,3-dimethyl-3-(t-amylperoxy)butanol, di(2-phenoxyethyl)peroxydicarbonate, di(4-t-butylcyclohexyl)peroxydicarbonate, dimyristyl peroxydicarbonate, dibenzyl peroxydicarbonate, di(isobornyl)peroxydicarbonate, 3-cumylperoxy-1,3-dimethylbutyl methacrylate, 3-t-butylperoxy-1,3-dimethylbutyl methacrylate, 3-t-amylperoxy-1,3-dimethylbutyl methacrylate, tri (1,3-dimethyl-3-t-butylperoxy butyloxy)vinyl silane, 1,3-dimethyl-3-(t-butylperoxy)butyl N-[1-{3-(1-methylethenyl)-phenyl) 1-methylethyl]carbamate, 1,3-dimethyl-3-(t-amylperoxy)butyl N-[1-13 (1-methylethenyl)-phenyl}-1-methylethyl]carbamate, 1,3-dimethyl-3-(cumylperoxy))butyl N-[1-3-(1-methylethenyl)-phenyl 1-1-methylethyl]carbamate, 1,1-di(t-butylperoxy)-3,3,5-trimethylcyclohexane, 1,1-di(t-butylperoxy)cyclohexane, n-butyl 4,4-di(t-amylperoxy)valerate, ethyl 3,3-di(t-butylperoxy)butyrate, 2,2-di(t-amylperoxy)propane, 3,6,6,9,9-pentamethyl-3-ethoxycabonylmethyl-1,2,4,5-tetraoxacyclononane, n-buty 1-4,4-bis(t-butylperoxy)valerate, ethyl-3,3-di(t-amylperoxy)butyrate, benzoyl peroxide, OO-t-butyl-O-hydrogen-monoperoxy-succinate, OO-t-amyl-O-hydrogen-monoperoxy-succinate, 3,6,9, triethyl-3,6,9-trimethyl-1,4,7-triperoxynonane (or methylethyl ketone peroxide cyclic trimer), methyl ethyl ketone peroxide cyclic dimer, 3,3,6,6,9,9-hexamethyl-1,2,4,5-tetraoxacyclononane, 2,5-dimethyl-2,5-di(benzoylperoxy)hexane, t-butyl perbenzoate, t-butylperoxy acetate,t-butylperoxy-2-ethyl hexanoate, t-amyl perbenzoate, t-amyl peroxy acetate, t-butyl peroxy isobutyrate, 3-hydroxy-1,1-dimethyl t-butyl peroxy-2-ethyl hexanoate, OO-t-amyl-O-hydrogen-monoperoxy succinate, OO-t-butyl-O-hydrogen-monoperoxy succinate, di-t-butyl diperoxyphthalate, t-butylperoxy (3,3,5-trimethylhexanoate), 1,4-bis(t-butylperoxycarbo)cyclohexane, t-butylperoxy-3,5,5-trimethylhexanoate, t-butyl-peroxy-(cis-3-carboxy)propionate, allyl 3-methyl-3-t-butylperoxy butyrate, OO-t-butyl-O-isopropylmonoperoxy carbonate, OO-t-butyl-O-(2-ethyl hexyl)monoperoxy carbonate, 1,1,1-tris[2-(t-butylperoxy-carbonyloxy)ethoxymethyl]propane, 1, 1,1-tris[2-(t-amylperoxy-carbonyloxy)ethoxymethyl]propane, 1, 1,1-tris[2-(cumylperoxy-cabonyloxy)ethoxymethyl]propane, OO-t-amyl-O-isopropylmonoperoxy carbonate, di(4-methylbenzoyl)peroxide, di(3-methylbenzoyl)peroxide, di(2-methylbenzoyl)peroxide, didecanoyl peroxide, dilauroyl peroxide, 2,4-dibromo-benzoyl peroxide, succinic acid peroxide, dibenzoyl peroxide, di(2,4-dichloro-benzoyl)peroxide, and combinations thereof.

Crosslinking Co-Agents

It is also envisioned that crosslinking co-agent may be combined in the polymer composition. Crosslinking co-agents create additional reactive sites for crosslinking, allowing the degree of polymer crosslinking to be considerably increased from that normally obtained solely by the addition of peroxide. Generally, co-agents increase the rate of crosslinking. In one or more embodiments, the crosslinking co-agents may include Triallyl isocyanurate (TAIC), trimethylolpropane-tris-methacrylate (TRIM), triallyl cyanurate (TAC), trifunctional (meth)acrylate ester (TMA), N,N′-m-phenylene dimaleimide (PDM), poly(butadiene) diacrylate (PBDDA), high vinyl poly(butadiene) (HVPBD), poly-transoctenamer rubber (TOR) (Vestenamer®), and combinations thereof

Foaming Agent

Polymer compositions in accordance with the present disclosure may include one or more foaming agents to produce expanded polymer compositions and foams. Foaming agents may include solid, liquid, or gaseous foaming agents. In embodiments utilizing solid foaming agents, foaming agents may be combined with a polymer composition as a powder or granulate.

Foaming agents in accordance with the present disclosure may include chemical foaming agents that decompose at polymer processing temperatures, releasing the foaming gases such as N₂, CO, CO₂, and the like. Examples of chemical foaming agents may include organic foaming agents, including hydrazines such as toluenesulfonyl hydrazine, hydrazides such as oxydibenzenesulfonyl hydrazide, diphenyl oxide-4,4′-disulfonic acid hydrazide, and the like, nitrates, azo compounds such as azodicarbonamide, cyanovaleric acid, azobis(isobutyronitrile), and N-nitroso compounds and other nitrogen-based materials, and other compounds known in the art.

Inorganic chemical foaming agents may include carbonates such as sodium hydrogen carbonate (sodium bicarbonate), sodium carbonate, potassium bicarbonate, potassium carbonate, ammonium carbonate, and the like, which may be used alone or combined with weak organic acids such as citric acid, lactic acid, or acetic acid.

Foaming Agent Accelerator

Polymer compositions in accordance with the present disclosure may include one or more foaming accelerators (also known as kickers) that enhance or initiate the action of a foaming agent by lower the associated activation temperature. For example, foaming accelerators may be used if the selected foaming agent reacts or decomposes at temperatures higher than 170° C., such as 220° C. or more, where the surrounding polymer would be degraded if heated to the activation temperature. Foaming accelerators may include any suitable foaming accelerator capable of activating the selected foaming agent. In one or more embodiments, suitable foaming accelerators may include cadmium salts, cadmium-zinc salts, lead salts, lead-zinc salts, barium salts, barium-zinc (Ba—Zn) salts, zinc oxide, titanium dioxide, triethanolamine, diphenylamine, sulfonated aromatic acids and their salts, and the like.

Elastomers

Polymers compositions in accordance with one or more embodiments of the present disclosure may include one or more elastomers. Elastomers in accordance with the present disclosure may include one or more of natural rubber, poly-isoprene (IR), styrene and butadiene rubber (SBR), polybutadiene, nitrile rubber (NBR); polyolefin rubbers such as ethylene-propylene rubbers (EPDM, EPM), and the like, acrylic rubbers, halogen rubbers such as halogenated butyl rubbers including brominated butyl rubber and chlorinated butyl rubber, brominated isotubylene, polychloroprene, and the like; silicone rubbers such as methylvinyl silicone rubber, dimethyl silicone rubber, and the like, sulfur-containing rubbers such as polysulfidic rubber; fluorinated rubbers; thermoplastic rubbers such as elastomers based on styrene, butadiene, isoprene, ethylene and propylene, styrene-isoprene-styrene (SIS), styrene-ethylene-butylene-styrene (SEBS), styrene-butylene-styrene (SBS), and the like, ester-based elastomers, elastomeric polyurethane, elastomeric polyamide, and the like.

Plasticizers

Polymer compositions in accordance with one or more embodiments may include a plasticizer. The plasticizer may be phthalate based, such as: DOP, DOA, DINP, DEHP, DPHP, DIDP, DIOP, DEP, DIBP, and the like, adipate based, such as: DEHA, DMAD, DBS, DBM, DIBM, and the like, bio-based—such as: triethyl citrate, acetyl tributyl citrate, methyl ricinoleate, soybean oil, epoxidized soybean oil, other vegetable oils, and the like, trimellitates, azelates, benzoates, sulfonamides, organophosphates, glycols and polyethers, polymeric plasticizers, polybutene, and the like.

Wax

Polymer compositions in accordance with one or more embodiments may include wax, such as paraffin wax, polyethylene wax, microcrystalline and nanocrystalline wax, natural waxes (bee, carnauba, ceresin, etc.), petroleum waxes, and the like.

Fillers, Nanofillers and Additives

Polymer compositions in accordance with the present disclosure may include fillers, nanofillers and additives that modify various physical and chemical properties when added to the polymer composition during blending that include one or more polymer additives such as processing aids, lubricants, antistatic agents, clarifying agents, nucleating agents, beta-nucleating agents, slipping agents, antioxidants, compatibilizers, antacids, light stabilizers such as HALS, IR absorbers, whitening agents, inorganic fillers, organic and/or inorganic dyes, anti-blocking agents, processing aids, flame-retardants, plasticizers, biocides, adhesion-promoting agents, metal oxides, mineral fillers, glidants, oils, anti-oxidants, antiozonants, accelerators, and vulcanizing agents.

Polymer compositions in accordance with the present disclosure may include one or more inorganic fillers such as talc, glass fibers, marble dust, cement dust, clay, carbon black, feldspar, silica or glass, fumed silica, silicates, calcium silicate, silicic acid powder, glass microspheres, mica, metal oxide particles and nanoparticles such as magnesium oxide, antimony oxide, zinc oxide, inorganic salt particles and nanoparticles such as barium sulfate, wollastonite, alumina, aluminum silicate, titanium oxides, calcium carbonate, polyhedral oligomeric silsesquioxane (POSS), or recycled EVA. As defined herein, recycled EVA may be derived from regrind materials that have undergone at least one processing method such as molding or extrusion and the subsequent sprue, runners, flash, rejected parts, and the like, are ground or chopped. Polymer compositions in accordance with the present disclosure may include one or more nanofillers such as single wall carbon nanotubes, double and multiwall carbon nanotubes, nanocellulose, nanocrystalline cellulose, nanoclays, nanometric metallic or ceramic particles, and the like.

Bio-Based Carbon Content

In polymer compositions of one or more embodiments, the co- or ter-polymers that include a branched vinyl ester monomer and/or the secondary polymer may contain at least a portion of bio-based carbon. Specifically, in one or more embodiments, the polymer composition may exhibit a bio-based carbon content, as determined by ASTM D6866-18 Method B, of from 1% to 100%. Some embodiments may include at least 1%, 5%, 10%, 20%, 40%, 50%, 60%, 80%, or 100% bio-based carbon. The total bio-based or renewable carbon in the polymer composition may be contributed from a bio-based ethylene and/or a bio-based vinyl acetate.

Properties of Polymer Compositions

In one or more embodiments, polymer compositions in accordance with the present disclosure may be expanded and cured. Expanded polymer compositions in accordance with one or more embodiments may have an expansion ratio of 10% or more, 20% or more, 50% or more, 80% or more, 100% or more, 120% or more, 150% or more, 200% or more, 250% or more, or 300% or more.

Expanded polymer compositions in accordance with one or more embodiments of the present disclosure may have a density of 0.80 g/cm³ or less, 0.70 g/cm³ or less, 0.60 g/cm³ or less, 0.50 g/cm³ or less, 0.45 g/cm³ or less, 0.43 g/cm³ or less, 0.42 g/cm³ or less, 0.41 g/cm³ or less, 0.40 g/cm³ or less, 0.38 g/cm³ or less, 0.35 g/cm³ or less, 0.32 g/cm³ or less or 0.30 g/cm³ or less, 0.20 g/cm³ or less, 0.10 g/cm³ or less in accordance ASTM D792.

Expanded polymer compositions in accordance with one or more embodiments of the present disclosure may have an Asker C hardness as determined by JIS K7312 that ranges from a lower limit of any of 15, 20, 25, 30, 35, 40, 45, 50, or 55 to an upper limit of 40, 45, 50, 55, 60, 70, 75, 80, 85, or 90 Asker C, where any lower limit can be paired with any upper limit.

Expanded polymer compositions in accordance with one or more embodiments of the present disclosure may have a Shore 0 hardness as determined by ASTM D2240 that ranges from a lower limit of any of 20, 25, 30, 35, 40, 45, 50, or 55 to an upper limit of 40, 45, 50, 55, 60, 70, 75, 80, 85 or 90 Shore 0, where any lower limit can be paired with any upper limit.

Expanded polymer compositions in accordance with one or more embodiments of the present disclosure may have a resilience of at least 30%, at least 40%, at least 45%, at least 50%, at least 55%, at least 60%, at least 65%, or at least 70% as determined by DIN 53512.

Expanded polymer compositions in accordance with one or more embodiments of the present disclosure may have an abrasion of 700 mm³ or less, 600 mm³ or less, 500 mm³ or less, 400 mm³ or less, 300 mm³ or less, 200 mm³ or less, 150 mm³ or less, 140 mm³ or less, 130 mm³ or less, 120 mm³ or less, 110 mm³ or less, 100 mm³ or less, 75 mm³ or less or 50 mm³ or less as determined by ISO 4649:2017 measured with a load of 5 N.

Expanded polymer compositions in accordance with one or more embodiments of the present disclosure may have a shrinkage of 18% of less, 12% or less, 6% or less, 4% or less, 3% or less, 2.8% or less, 2.5% or less, 2.3% or less, or 2.0% or less as determined by using the PFI method (PFI “Testing and Research Institute for the Shoe Manufacturing Industry” in Pirmesens-Germany) at 70° C., for 1 h.

Expanded polymer compositions in accordance with one or more embodiments of the present disclosure may have a compression set of lower than 15%, lower than 12%, lower than 10%, or lower than 8% as determined by ASTM D395 using Method B at 23° C., 25% strain, for 22 hours, measured after 24 hours.

Expanded polymer compositions in accordance with one or more embodiments of the present disclosure may have a compression set of lower than 75%, lower than 70%, lower than 60%, lower than 55%, lower than 50%, lower than 45%, lower than 40%, or lower than 35%, as determined by ASTM D395 using Method B at 50° C., 50% strain, for 6 hours).

Expanded polymer compositions in accordance with one or more embodiments of the present disclosure may have a tear strength of at least 0.1 N/mm, at least 1 N/mm, at least 2 N/mm, at least 3 N/mm, at least 3.5 N/mm, at least 4 N/mm, at least 4.5 N/mm, at least 5 N/mm, or at least 10 N/mm as determined by ASTM D624.

Expanded polymer compositions in accordance with one or more embodiments of the present disclosure may have a bonding strength of at least 0.1 N/mm, at least 1.0 N/mm, at least 2.0 N/mm, at least 2.5 N/mm, at least 3.0 N/mm, at least 3.5 N/mm, at least 4.0 N/mm, at least 4.5 N/mm, at least 5.0 N/mm, or at least 10 N/mm, as determined by ABNT-NBR 10456.

Articles

Expanded polymer compositions in accordance with one or more embodiments of the present disclosure may be used for the production of a number of polymer articles for a diverse array of end-uses, but especially those where low softness and density, and good resilience and compression is desired. Such applications may include hot melt adhesives and impact modifiers. In addition, expanded articles of the disclosed compositions may be suitable for applications in the footwear industry, and in particular shoe soles, midsoles, outsoles, unisoles, insoles, monobloc sandals, flip flops, and sportive articles.

Methods

Polymer compositions in accordance with the present disclosure may be prepared in any conventional mixture device or means. In one or more embodiments, polymeric compositions may be prepared by mixture in conventional kneaders, Banbury mixers, mixing rollers, twin screw extruders, presses and the like, in conventional polymer processing conditions and subsequently cured or cured and expanded in conventional expansion processes, such as injection molding or compression molding.

It is also understood that upon being mixed with the other components forming the polymer composition, the polymer composition may also be cured by, for example, in the presence of peroxides, including those discussed above. For embodiments which include expanded compositions, the expanding and curing may be in the presence of a foaming agent and a peroxide, and optionally, a foaming accelerator. During any of such curing steps, in one or more embodiments, the curing may occur in full or partial presence of oxygen, such as described in WO201694161A1, which is incorporated by reference in its entirety.

The polymer composition may be extruded with an extruder that may provide for the injection of a gas, or when a chemical foaming agent is used, the blowing agent may be mixed with the polymer being fed into the extruder. Gas, either injected into the extruder or formed through thermal decomposition of a chemical blowing agent in the melting zone of the extruder. The gas (irrespective of the source of the gas) in the polymer forms into bubbles that distribute through the molten polymer. Upon eventual solidification or crosslinking of the molten polymer, the gas bubble results in a cell structure or foamed material. In particular embodiments, the cell structure of the expanded composition may be a closed cell structure.

The following examples are merely illustrative, and should not be interpreted as limiting the scope of the present disclosure.

### Materials and Methods

### Materials

### Examples 1-3

Ethylene (99.95%, Air Liquide, 1200 psi), VeoVa™ 10 (Hexion) and 2,2′-azobisisobutyronitrile (AIBN, 98% Sigma Aldrich), Calcium carbonate (Barralev C (Imerys)), zinc oxide (Vetec) Stearin (Baerolub FTA), azodicarbonamide MIKROFINE ADC-II by (HPL Additives), peroxide (Luperox 802G—Arkema)—40% of bisperoxide (1,4-bis[1-(tert-butylperoxy)-1-methylethyl]benzene) in calcium carbonate, TAC (triallyl cyanurate) (Rhenofit TAC (Lanxess))—70 wt % triallyl cyanurate bound to 30 wt % silica, Masterbatch of polydimetylsiloxane (PDMS)—ELEMNT14—Viscosity 60,000 mPa·s at 20° C., were used as received. Vinyl acetate (99%, Sigma Aldrich) was distilled before use and stored under nitrogen.

### Examples 4-6

The terpolymers were coded as DV001A and DV001B, where the chemical composition of DV001A was 5.6 wt. % VeoVa and 28.3 wt. % vinyl acetate (the remaining is ethylene); and DV001B was 9.3 wt. % VeoVa and 24.1 wt. % vinyl acetate (the remaining is ethylene). Example 4 contemplates samples made with DV001A, and Example 5 with DV001B.

For the foam formulation, Calcium Carbonate from Imerys, zinc oxide (pure, from Auriquimica), stearin (pure, from Baerlocher, Luperox 802G (Arkema—40% of bisperoxide in calcium carbonate), pure azodicarbonamide from Proquitec, EVA HM728 (28 wt. % and an MFR of 6 g/10 min), replacing a fraction of the terpolymers, from Braskem S.A. and neat PDMS (ELEMNT14—Viscosity 60,000 mPa·s at 20° C.) were used.

### Methods

### Examples 1-3

An ethylene-based copolymer was used as the base polymer for Example 1. The terpolymer was synthesized in lab-scale high pressure reactor, with the following conditions: mixtures of VeoVa™ 10 (from HEXION), solvent and initiator fed the reactor, which were purged with nitrogen for ten minutes before use. Before each round of polymerization, the reactor was purged five times with 2200-2300 bar of ethylene. Each reaction began by heating the reactor to 190° C. and feeding ethylene to a pressure of 1900-2000 bar. The final composition contained 22.35 wt. % of VeoVa.

Ethylene-based terpolymers were used as the base polymer for Examples 2 and 3, polymerized using the same reaction conditions as in example 1. The resulting terpolymers had the following chemical composition—example 2: 8.44 wt. % VeoVa and 21.17 wt. % vinyl acetate (the remaining is ethylene); example 3—5.8 wt % VeoVa and 25.8 wt % vinyl acetate (the remaining is ethylene).

The base polymer used for Comparative Example 1 was a commercial grade ethylene vinyl acetate (EVA) polymer available from Braskem, namely HM728 which has a vinyl acetate content of 28 wt. % and a melt flow rate (MFR) of 6 g/10 min (190° C./2.16 kg as measured by ASTM D 1238).

The base polymer used for Comparative Example 2 was a commercial grade EVA polymer available from Braskem, namely EVANCE VA5018ALS which has a vinyl acetate content of 22 wt. % and a MFR of 2 g/10 min (190° C./2.16 kg as measured by ASTM D 1238).

The components were compounded in an internal mixer (HAAKE™ Rheomix OS Lab Mixer, equipped with roller rotors) for a total mixing time necessary for torque stabilization. The resulting material was removed while it was still warm and compressed manually to form sheets between two Mylar® films. The compressed sheets were cut, stacked, and compression molded in a closed dye using a hydraulic press (Luxor model LPB-100-AQ-EVA). The following compositions (Tables 1 and 2) were mixed and molded under these conditions.

Hot expansion was controlled to be about 64% for all samples in Table 1 in order to isolate the effect of polymer composition on the material properties. When evaluating similar compositions and having expansion as an outcome, for the co- and ter-polymers, and both comparative examples, the following formulations were compounded, cured, and the properties were tested as shown in Table 2.

TABLE 1

| | Example 1: | | Example 2: | | Example 3: | | Comparative | | Comparative | |
|---|---|---|---|---|---|---|---|---|---|---|
| | Copolymer | | Terpolymer | | Terpolymer | | Example 1 | | Example 2 | |
| Component | phr | wt % | phr | wt % | phr | wt % | phr | wt % | phr | wt % |
| Base polymer | 98 | 83.90 | 98 | 84.12 | 98 | 84.12 | 100 | 85.47 | 100 | 85.69 |
| CaCO₃ (ground) | 10 | 8.56 | 10 | 8.58 | 10 | 8.58 | 10 | 8.55 | 10 | 8.57 |
| ZnO | 2 | 1.71 | 2 | 1.72 | 2 | 1.72 | 2 | 1.71 | 2 | 1.71 |
| Stearin | 1 | 0.86 | 1 | 0.86 | 1 | 0.86 | 1 | 0.85 | 1 | 0.86 |
| Azocarbonamide | 1.5 | 1.28 | 1.5 | 1.29 | 1.5 | 1.29 | 2 | 1.71 | 1.7 | 1.46 |
| Peroxide (802 g) | 2 | 1.71 | 2 | 1.72 | 2 | 1.72 | 2 | 1.71 | 2 | 1.71 |
| TAC | 0.3 | 0.26 | — | — | — | — | — | — | — | — |
| Dimethylsiloxane | 2 | 1.71 | 2 | 1.72 | 2 | 1.72 | — | — | — | — |

TABLE 2

| | Example 1: | | Example 2: | | Comparative | | Comparative | |
|---|---|---|---|---|---|---|---|---|
| | Copolymer | | Terpolymer | | Example 1 | | Example 2 | |
| Component | phr | wt % | phr | wt % | phr | wt % | phr | wt % |
| Base polymer | 100 | 84.82 | 100 | 85.47 | 100 | 85.47 | 100 | 85.47 |
| CaCO₃ (ground) | 10.00 | 8.48 | 10.00 | 8.55 | 10.00 | 8.55 | 10.00 | 8.55 |
| ZnO | 2.00 | 1.70 | 2.00 | 1.71 | 2.00 | 1.71 | 2.00 | 1.71 |
| TAC | 0.30 | 0.25 | — | — | — | — | — | — |
| Stearin | 1 | 0.85 | 1 | 0.85 | 1 | 0.85 | 1 | 0.85 |
| Azocarbonamide | 2.00 | 1.70 | 2.00 | 1.71 | 2.00 | 1.71 | 2.00 | 1.71 |
| Peroxide BIS 40% | 2.60 | 2.20 | 2.00 | 1.71 | 2.00 | 1.71 | 2.00 | 1.71 |

The compounds were tested for density (ASTM D792), hardness (JIS K7312), resilience (ASTM D2632), abrasion (ISO 4649), compression set (ASTM D395), and crosslinking degree (gel content and torque increase in RPA). Samples for compression set testing were produced from cutting standard specimen with a circular die, as described in ASTM 395.

The gel content was measured upon extraction in xylene. This extraction was performed for 8 hours in boiling xylene, with the use of about 1 gram of sample inside a 120 mesh sieve, followed by drying in oven for constant weight (about 1 hour). Finally, the gel content is calculated as the percentage of retained material in the sieve.

Curing in a rubber process analyzer (RPA) was carried at 175° C., where MH-ML is the torque increase upon curing (being MH the torque prior to, and ML, after cure) and is proportional to the formed crosslinking density. Tc90 is the time needed to achieve 90% of the maximum achieved torque in the analysis, Tc50 is the time needed to achieve 50% of the maximum achieved torque, and Ts1 is the time required so the torque reaches 1 dN·m, Tc90 is a reference for the minimum time required for an adequate cure in this particular condition. PL is the maximum pressure in the chamber upon foaming.

Samples in Table 2 were also tested for and cell size, which was determined by scanning electron microscopy (SEM™-1000/Hitachi), through counting of approximately 200 cells, with a 200× magnification, and the average cell diameter distribution was obtained through the graphical analysis and statistics from the software LAS 4,9/LEICA.

### Examples 4 and 5

Terpolymer samples coded as DV001A and DV001B were produced in a high pressure industrial asset that normally operates producing EVA copolymers. DV001A is a terpolymer comprising 5.6 wt. % of VeoVa™ 10 and 28.3 wt. % of vinyl acetate; and DV001B is a terpolymer comprising 9.3 wt. % VeoVa™ 10 and 24.1 wt. % of vinyl acetate (the remainder being ethylene). Example 4 contemplates polymer composition samples comprising DV001A and Example 5, polymer composition samples comprising DV001B. The general reactor conditions to the production of the terpolymers are described in Table 3.

TABLE 3

| Parameter | DV001A | DV001B |
|---|---|---|
| Pressure reactor 1 (kgf/cm²) | 1820-1840 | 1820-1840 |
| Temperatures reactor 1 (average) (° C.) | 164.5 | 164.5 |
| Pressure reactor 2 (kgf/cm²) | 1780-1800 | 1770-1790 |
| Temperatures reactor 2 (average) (° C.) | 161.7 | 163.7 |
| Production rate (kg/h)* | 6000 | 6000 |
| VA feed rate (kg/h) | 2850-3200 | 2400 |
| Ethylene feed rate (kg/h) | 4270 | 4300 |
| VeoVa feed rate (kg/h) | 800-900 | 1650 |

* Difference in feed rate sum and production rate due to condensation of the comonomers and their low pressure recycle gas/liquid compressor separator.
The condensed VeoVa was not reinjected.
Part of unreacted VeoVa remains soluble in the polymer, being removed in a further step of air purge at the sylos.

Ethylene-vinyl acetate-VeoVa terpolymers were used as the base material for a full multilevel factorial experiment, which was performed using the software Minitab® 19.2020.1 (64-bit), in one replication, considering four factors, with the variation of two levels (−1 and 1) for terpolymer chemical composition (different degrees of vinyl acetate substitution by VeoVa), peroxide and chemical foaming agent (CFA) contents, and three levels (−1, 0 and 1) for blending with EVA with 28 wt % VA, totalizing 24 experiments. Specific values for the levels are described in Table 4.

TABLE 4

| Component | Level −1 | Level 0 | Level 1 |
|---|---|---|---|
| Polymer type | DV001A | — | DV001B |
| Blend with EVA (wt %) | 0 | 30 | 70 |
| Azodicarbonamide (phr) | 1.5 | — | 3 |
| Luperox 802G (phr) | 1.7 | — | 2.2 |

A base formulation in which the experiment was based on contained 100 phr of polymer, 10 phr of Calcium Carbonate, 2 phr of zinc oxide and 1 phr of stearin. Regarding the components that have changed in content, Luperox 802G (Arkema—40% of bisperoxide in calcium carbonate), azodicarbonamide, and EVA HM728 (replaced a fraction of the terpolymers) from Braskem S.A. were used.

For Examples 4 and 5, the following formulations (obtained via the multilevel factorial experiment) displayed in Table 5 (covers both examples, with the difference that Example 4 has DV001A as the base polymer, and Example 5, DV001B) were evaluated:

TABLE 5

| | Blend-HM728 | A[O] | Blowing agent |
|---|---|---|---|
| Sample | (phr) | (phr) | (phr) |
| 1 | 0 | 1.7 | 1.5 |
| 2 | 0 | 1.7 | 3 |
| 3 | 0 | 2.2 | 1.5 |
| 4 | 0 | 2.2 | 3 |
| 5 | 30 | 1.7 | 1.5 |
| 6 | 30 | 1.7 | 3 |
| 7 | 30 | 2.2 | 1.5 |
| 8 | 30 | 2.2 | 3 |
| 9 | 70 | 1.7 | 1.5 |
| 10 | 70 | 1.7 | 3 |
| 11 | 70 | 2.2 | 1.5 |
| 12 | 70 | 2.2 | 3 |

The compounding was performed in a Banbury from Quanzhou Yuchengsheng Machine CO., LTD, Model XSN-5 for 15-20 minutes, reaching a temperature of 115° C. All materials (except for the peroxide and chemical foaming agent) fed the kneader initially, and after initial dispersion, the peroxide and CFA were added. After mixing, a sheet of material with a thickness of approximately 1.7 mm was produced by a mill roll from Mecanoplast, at 50° C. After a period of 90 hours, 93 grams of the sheet fed a hydraulic hot press using a mold with the internal dimensions of 10×10 cm, external dimensions of 15×15 cm, and height of 1 cm, and foams were produced via compression molding with a pressure of 15 ton, temperature of 179° C., for 8 minutes.

Samples for density (disks with a diameter of 15 mm) were cut from the molded part with a hole saw. The same procedure (but with a 29 mm diameter) was used to the compression set samples. The rebound resilience and hardness tests were performed in a 5×5 cm square, cut from a corner of the plate, and the tensile test was performed in die cut specimens (type C—ASTM D412) from cut sheets from the compression molded plates (3-4 mm thickness).

The measured properties were expansion (size of the part immediately after molding, and after complete cooling—˜1 week after compression molding), hardness (Asker C—JIS K7312 and Shore O—ASTM D2240); rebound resilience (pendulum, DIN 53512:2000); density by water displacement (ASTM D792); compression set @ 50% deformation, 50° C., 6 hours, with a cooling time after test of 30 minutes (ASTM D395); abrasion wear (sandpaper #60 and a load of 5 N (according to ISO 4649:2017)); shrinkage (PFI method, oven, 70° C., for 1 h)—reported average of shrinkage in orthogonal directions, not considering the thickness); tensile test according to an adaptation of ASTM D638, following further instructions from the footwear industry (samples climatizing at 23±2° C., 50±5% RH, test at the same conditions, test speed of 500 mm/min), where tensile modulus, stress and strain at break were recorded.

### Example 6

The following formulations in Table 6, made with terpolymers DV001A and DV001B, and the EVAs from Comparative Examples 1 and 2 from Examples 1, 2 and 3, with similar formulations and very similar expansion ratios, were produced in order to evaluate cushion properties, as well as deformation via dynamic compression.

TABLE 6

| Sample | 1 | 2 | 3 | 4 |
|---|---|---|---|---|
| Component | DV001A | DV001B | EVANCE | EVA |
| | | | VA5018ALS | HM728 |
| Polymer | 100 | 100 | 100 | 100 |
| Calcium carbonate | 10 | 10 | 10 | 10 |
| Zinc oxide | 2 | 2 | 2 | 2 |
| Stearin | 1 | 1 | 1 | 1 |
| Azocarbonamide | 2.3 | 2.3 | 1.5 | 1.5 |
| Peroxide BIS 40% | 2 | 2 | 2.2 | 2.2 |
| PDMS | 2 | 2 | — | — |
| Expansion after 24 h after | 55 | 55 | 54 | 54 |
| compression molding (%) | | | | |

The compounding was performed in a Banbury from Quanzhou Yuchengsheng Machine CO., LTD, Model XSN-5 for 15-20 minutes, reaching a temperature of 115° C. All materials (except for the peroxide and chemical foaming agent) fed the kneader initially, and after initial dispersion, the peroxide and CFA were added. After mixing, a sheet of material with a thickness of approximately 1.7 mm was produced by a mill roll from Mecanoplast, at 50° C. After a period of approximately 90 hours, pieces of the sheet were cut into squares with the approximate dimensions of the used mold and compression molded with a hot press LUXOR LPB-100-AQ-EVA with a temperature of 175° C. for 8 minutes.

Samples for density (disks with a diameter of 15 mm) were cut from the molded part with a hole saw. The same procedure (but with a 29 mm diameter) was used to the compression set samples. The rebound resilience and hardness tests were performed in a 5×5 cm square, cut from a corner of the plate, or for sample 1 and 2, where a smaller sample was produced, resilience was tested in the middle of the molded sample.

Dynamic properties were also evaluated. Deformation by dynamic compression (according to ABNT NBR 14739:2021), with the following testing conditions: 100000 deformation cycles, load of 400 N and compression frequency 65±4 cycles/minute, in 30×30 mm specimens cut from compression molded plates, without inclination, with disc 75 mm in diameter; and cushioning properties test—cushion energy and factor at 113 and 216 N, and hysteresis (according to SATRA™ 159:2018), using samples from compression molded plates with 20 mm diameter, and a compression rate of 20±0.5 mm/min, all samples climatized at 23±2° C., 50±5% RH for at least 24 hours, according to ABNT NBR (10455:2021).

Cushioning properties tests are used to assess the cushioning properties of a material or assembly. It is primarily applicable to insocks (footbeds) and footwear midsoles but can also be used to any material intended for cushioning. The main goals of the test are to determine the cushion energy (CE) and cushion factor (CF) under a compressive stress. CE is defined as the energy required to compress a specimen up to certain force, and the CF, is defined as: CF=(Thickness×Force)/CE. CE and CF were determined using two different forces: CEw is defined as the energy absorbed by the test specimen when subjected to pressures similar to those experienced during walking (113 N), and CEr is the energy absorbed by the test specimen when subjected to pressures similar to those experienced during running (216 N).

The samples were submitted to 5 cycles of compression up to 245 N, for sample preconditioning. After the specimen was compressed to the specific maximum force (216 N to evaluate CEr and CFr), where the force x displacement curves were recorded both at the compression, and the release of the stress. This process was repeated 4 more times. The data of this tests were selected also up to 113 N to determine CEw and CFw.

The absorbed energy was calculated using Simpson's numerical integration method. Hysteresis (difference between compression and the release energies) were calculated to evaluate the return of stored energy of the foam, which is relevant for applications in footwear. The reported results (energy and factors) were the average of the 5 compression/release cycles, while the hysteresis was calculated from those averages.

### Example 7

Samples with the formulation in the Tables 7 and 8 were produced first mixing in an internal mixer (Banbury) for 15-20 minutes, reaching a maximum temperature of 115° C., with formulation adjustments in a cylinder at 50° C., followed by calendering sheets (thickness of 2.5 mm) at 50° C. The sheets were compression molded in an appropriated hydraulic press for 40 minutes at 160° C., and then insoles were thermoformed from the compression molded plates at 190° C. for 90 seconds.

The peroxide formulation used comprises 40 wt % of 1,4-bis[1-(tert-butylperoxy)-1-methylethyl]benzene. The other components were used in the pure form.

The following characterization tests were used:

Hardness (Asker C—performed according to NBR 14455: test performed in the opposite side of the fabric for samples 1-4, while samples 5-10 had no fabric. Specimens piled up to complete adequate thickness;

Rebound resilience (pendulum, according to DIN 53512:2000): test performed in the opposite side of the fabric for samples 1-4, while samples 5-10 had no fabric. Specimens piled up to adequate thickness;

Density by water displacement (according to ISO 2781): The fabric was removed prior to the density test for samples 1-4, while samples 5-10 had no fabric, and specimens were climatized for 24 h at 23±2° C., 50±RU;

Compression set: Samples 5 to 10-23±2° C., deformation of 25% for 22 h—according to ASTM D395:2018—Method B, Specimens Type 1: Specimens die-cut and piled up to the desired thickness. Samples were climatized for 24 h at 23±2° C., 50±RU. Samples 5-10 had no fabric.

Shrinkage in oven (PFI method, 70° C., for 1 h): Test was performed without removing the fabric for samples 1-4, while samples 5-10 had no fabric.

TABLE 7

| | 1 | 2 | 3 | 4 |
|---|---|---|---|---|
| Component | phr | phr | phr | phr |
| DV001A | 100 | — | 100 | — |
| DV001B | — | 100 | — | 100 |
| Calcium carbonate | 10.00 | 10.00 | 10.00 | 10.00 |
| ZnO | 1.43 | 1.43 | 1.43 | 1.43 |
| Stearin | 1.43 | 1.43 | 1.43 | 1.43 |
| Chemical Foaming | 4.29 | 4.29 | 3.79 | 3.79 |
| agent (Azo) | | | | |
| Bis peroxide (40%) | 1.71 | 1.71 | 1.71 | 1.71 |

TABLE 8

| Component | 5 phr | 6 phr | 7 Phr | 8 phr | 9 phr | 10 phr |
|---|---|---|---|---|---|---|
| PN2021 (EVA | 100.00 | 80.00 | 60.00 | 40.00 | 20.00 | 0.00 |
| from Braskem | | | | | | |
| S.A.) | | | | | | |
| DV001B | 0.00 | 20.00 | 40.00 | 60.00 | 80.00 | 100.00 |
| Calcium | 7.00 | 7.00 | 7.00 | 7.00 | 7.00 | 7.00 |
| carbonate | | | | | | |
| ZnO | 0.30 | 0.30 | 0.30 | 0.30 | 0.30 | 0.30 |
| Q-72 | 0.50 | 0.50 | 0.50 | 0.50 | 0.50 | 0.50 |
| (Processing aid) | | | | | | |
| Stearin | 0.30 | 0.30 | 0.30 | 0.30 | 0.30 | 0.30 |
| Recycled | 33.00 | 33.00 | 33.00 | 33.00 | 33.00 | 33.00 |
| formulation | | | | | | |
| Chemical | 5.80 | 5.80 | 5.80 | 5.80 | 5.80 | 5.80 |
| foaming agent | | | | | | |
| (Azodicarbon- | | | | | | |
| amide) | | | | | | |
| Bis peroxide | 1.60 | 1.60 | 1.60 | 1.60 | 1.60 | 1.60 |
| (40 wt %) | | | | | | |
| TOTAL | 148.50 | 148.50 | 148.50 | 148.50 | 148.50 | 148.50 |

### Results

### Examples 1-3

The compositions and properties of Examples 1-3 and comparative examples 1 and 2, controlling formulation for obtaining similar expansion upon foaming, may be found in Table 9, below.

TABLE 9

| | Example 1: | Example 2: | Example 3: | Comp. | Comp. |
|---|---|---|---|---|---|
| Properties | Copolymer | Terpolymer | Terpolymer | Ex. 1 | Ex. 2 |
| Density (g/cm³) | 0.214 | 0.26 | 0.260 | 0.256 | 0.27 |
| Hardness (Asker C) | 49 | 50 | 49 | 61 | 48 |
| Gel content (wt %) | 84.47 | 90.58 | — | 95.24 | 89.33 |
| ML (kgfcm) | −0.01 | −0.01 | — | 0.06 | 0.08 |
| MH (kgfcm) | 0.35 | 0.67 | — | 1.82 | 1.37 |
| MH-ML (kgf · cm) | 0.36 | 0.68 | — | 1.76 | 1.29 |
| Ts1 | — | — | — | 3′07″ | 3′45″ |
| Tc50 | 3′21″ | 3′21″ | — | 2′57″ | 2′51″ |
| Tc90 | 4′43″ | 4′39″ | — | 4′23″ | 4′22″ |
| Resilience | 42 | 54 | 46 | 54 | 58 |
| Expansion (hot) (%) | 65.5 | 64 | — | 64 | 64 |
| Expansion (cold) (%) | 56 | 53 | 54 | 56 | 53 |
| Abrasion (mm³/30 m) | 247 | 82 | 99 | 283 | 110 |
| Compression set (50° C., 50%, | 74.39 | 60.18 | — | 42.53 | 54.19 |
| 6 h) | | | | | |

Hot expansion was controlled to be about 64% and cold expansion to be in the range of 53-56% for all samples in order to isolate the effect of polymer composition on the material properties. The gel content (crosslinked, insoluble fraction of the polymer) and the A Torque (MH-ML, increase in torque in RPA) are lower for example 1 and example 2 as compared to the comparative samples. This may be indicative of different cure behavior, and possibly, a lower molar mass for example 1 and example 2. Examples 2 and 3 (the terpolymers) achieve a similar level of density when compared to comparative example 1 (EVA HM728), a lower hardness (within desired range for such application), and similar resilience to Example 2 and lower than Example 3, which could be explained due to aspects of comonomer content, as well as molecular weight. The compression set values of examples 1 and 2 were higher than for the comparative samples, although this can be optimized upon changes in peroxide and crosslinking co-agent content. The addition of the masterbatch of dimethylsiloxane (˜1.7 wt %) resulted in the reduction of abrasion of the Examples 2 and 3 polymers (the terpolymers) to significantly lower levels when compared to comparative example 1 (283 vs 82 and 99 mm³).

When evaluating similar compositions and having expansion as an outcome, for the co- and ter-polymers, and both comparative examples, the following formulations were compounded, cured, and the properties were tested as shown in Table 10, below.

TABLE 10

| | Example 1: | | Example 2: | | Comparative | | Comparative | |
|---|---|---|---|---|---|---|---|---|
| Properties | Copolymer | | Terpolymer | | Example 1 | | Example 2 | |
| Density | 0.156 | g/cm³ | 0.198 | g/cm³ | 0.245 | g/cm³ | 0.238 | g/cm³ |
| Hardness (asker C) | 33 | C | 39 | C | 55 | C | 36 | C |
| Ts1 | 0-00 | | 0-00 | | 02:56 | | 03:41 | |
| Tc90 | 4-31 | | 4-38 | | 06:24 | | 06:32 | |
| ML | −0.01 | | −0.01 | | 0.06 | | 0.08 | |
| MH | 0.83 | | 0.53 | | 2.27 | | 1.71 | |
| MH-ML | 0.84 | | 0.54 | | 2.21 | | 1.63 | |
| PL | 84.63 | | 80.38 | | — | | — | |
| Cell size | 42 | μm | 86 | μm | 37 | μm | 27 | μm |

| | | | | |
|---|---|---|---|---|
| Gel content | 86.26% | 87.69% | 94.37% | 90.96% |
| Expansion (cold) | 72% | 60% | 54% | 67% |
| Compression set | | | | |
| (23° C. 22 h. 25%)- | 9.50% | 12% | 4.90% | 5.60% |
| measured after 24 h | | | | |

The gel content (crosslinked, insoluble fraction of the polymer) and the A Torque (MH-ML, increase in torque in RPA) are lower for example 1 and example 2 when compared to the comparative samples. This may be indicative of different cure behavior, and possibly, a lower molar mass for Example 1 and Example 2.

Example 2 exhibits a lower density when compared to the comparative samples even though they have the same foaming agent and accelerator contents. This may be due to a more intense cell growth in these materials, as indicated through its larger average cell size, which may possibly be due to lower viscosity (lower ML). Another interesting property of the example compounds is the lower hardness, being below 40 Asker C, which could be useful in a variety of applications. This lower hardness could be used to optimize an overall balance of properties, enabling softer formulations for shoe midsoles, for example. The compression set values were higher for examples 1 and 2 as compared to the comparative samples, although this can be optimized with changes in peroxide and crosslinking co-agent content.

### Example 4

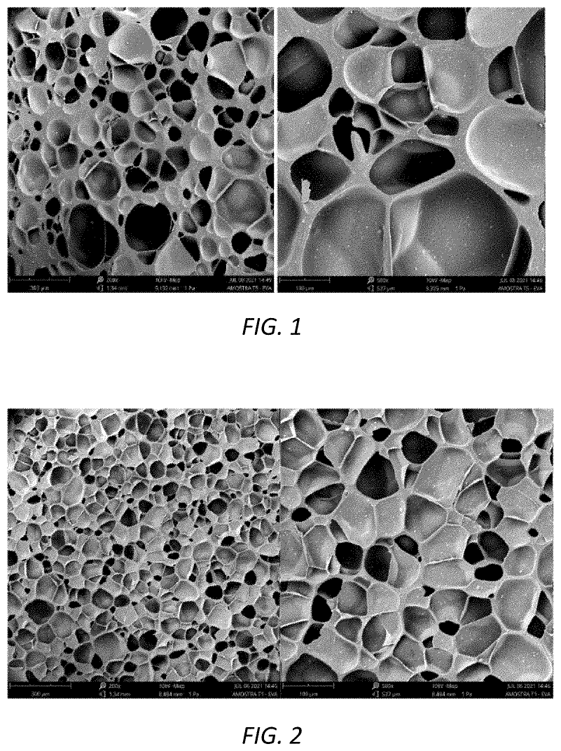

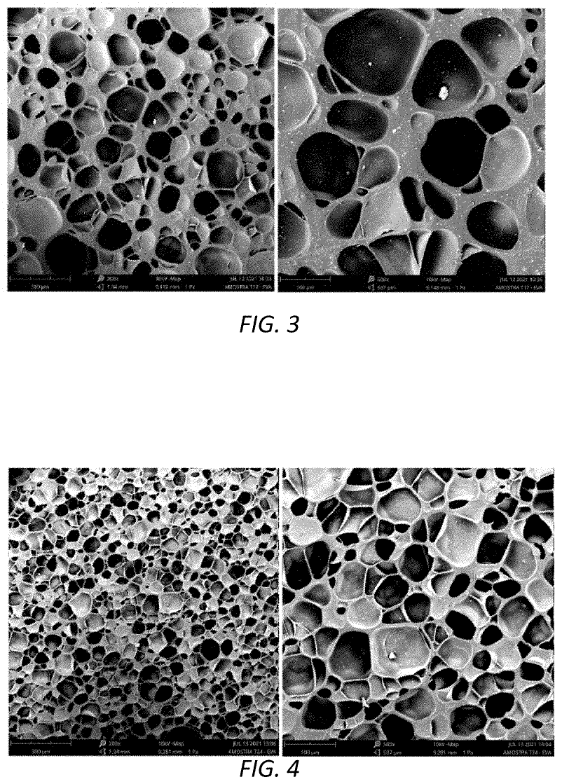

The design of experiments with the base polymer DV001A (˜5 wt % VeoVa™ 10) led to the following ranges of properties observed for Example 4, testing conducted as described previously. Results are displayed in Table 11. Microstructures of the samples are shown in FIGS. 1-4.
Expansion (hot)—From 137.5 to 190;
Expansion (after cooling)—From 129 to 173;
Hardness (Asker C): From 40 to 71;
Hardness (Shore 0): From 33.1 to 63.1;
Resilience: From 46 to 59%;
Compression set (50° C., 50% def, 6 h): From 39.2 to 53.7%;
Density: From 0.167 to 0.419 g/cm³;
Stress at break: From 1.7 to 3.1 MPa;
Strain at break: From 382 to 723%;
Tensile modulus @ 300%: 0.32 to 0.75 MPa;
Abrasion wear: From 81 to 475 mm³;

Average shrinkage (oven, 70° C., 1 h): From 4.2 to 7.7%.

TABLE 11

| | | | | | | Compression | | | | Tensile | | Shrink- |
|---|---|---|---|---|---|---|---|---|---|---|---|---|
| | Expansion | Expansion | | | | Set (50° C., | | Stress | Strain | modulus | Abrasion | age |
| Sam- | (hot) | (cold) | Hardness | Hardness | Resilience | 50%, 6 h) | Density | at break | at break | @ 300% | wear | (70° C., |
| ple | (%) | (%) | (Asker C) | (Shore O) | (%) | (%) | (g/cm³) | (MPa) | (%) | (MPa) | (mm³) | 1 h) |
| 1 | 152.5 | 141 | 61 | 51.4 | 47 | 52.1 | 0.327 | 2.1 ± 0.1 | 514 ± 24.4 | 0.60 | 149 | 5.7 |
| 2 | 190 | 173 | 40 | 33.1 | 55 | 41.2 | 0.170 | 1.7 ± 0.1 | 567 ± 12.2 | 0.32 | 461 | 5.9 |
| 3 | 142 | 131 | 69 | 59.8 | 52 | 53.7 | 0.396 | 2 ± 0.1 | 481 ± 23.3 | 0.62 | 87 | 7.7 |
| 4 | 174.5 | 162 | 49 | 40.7 | 59 | 43.9 | 0.206 | 1.9 | 391 ± 11.2 | 0.54 | 339 | 7.2 |
| 5 | 152 | 139 | 65 | 54.9 | 49 | 45.3 | 0.323 | 2.5 ± 0.1 | 617 ± 22.2 | 0.59 | 148 | 5 |
| 6 | 185 | 170 | 44 | 35.6 | 55 | 41.7 | 0.169 | 2 ± 0.1 | 515 ± 14 | 0.43 | 475 | 5 |
| 7 | 137.5 | 129 | 69 | 62.4 | 46 | 50.6 | 0.419 | 2.8 ± 0.1 | 555 ± 21.5 | 0.74 | 81 | 7.5 |
| 8 | 177 | 163 | 50 | 40.4 | 52 | 41.6 | 0.208 | 1.9 ± 0.1 | 382 ± 28.4 | 0.57 | 375 | 7.2 |
| 9 | 153 | 140 | 65 | 54.7 | 47 | 49.0 | 0.318 | 3.1 ± 0.2 | 723 ± 55.7 | 0.54 | 133 | 4.2 |
| 10 | 186.5 | 171 | 45 | 36.7 | 55 | 47.7 | 0.167 | 1.7 ± 0.1 | 444 ± 19.6 | 0.42 | 450 | 4.4 |
| 11 | 137.5 | 130 | 71 | 63.1 | 46 | 51.5 | 0.406 | 2.6 ± 0.2 | 518 ± 36.4 | 0.75 | 81 | 6.8 |
| 12 | 172.5 | 162 | 53 | 43.6 | 56 | 39.2 | 0.214 | 2.2 | 438 ± 19.2 | 0.55 | 271 | 5.9 |

### Example 5

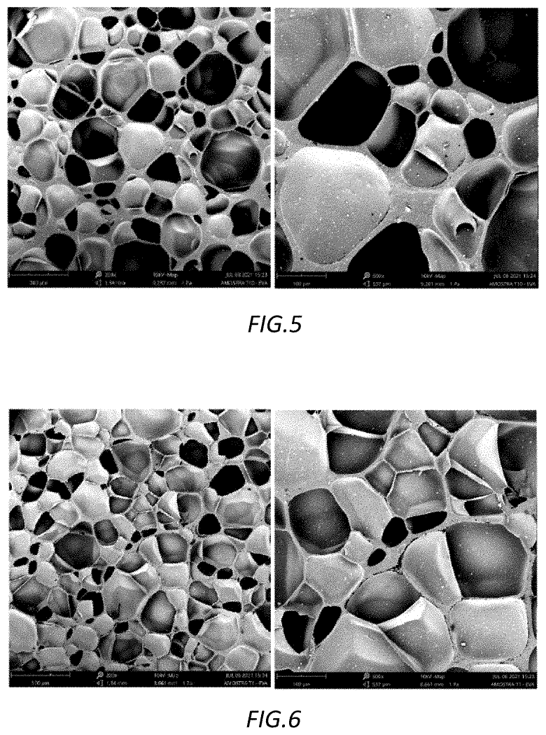

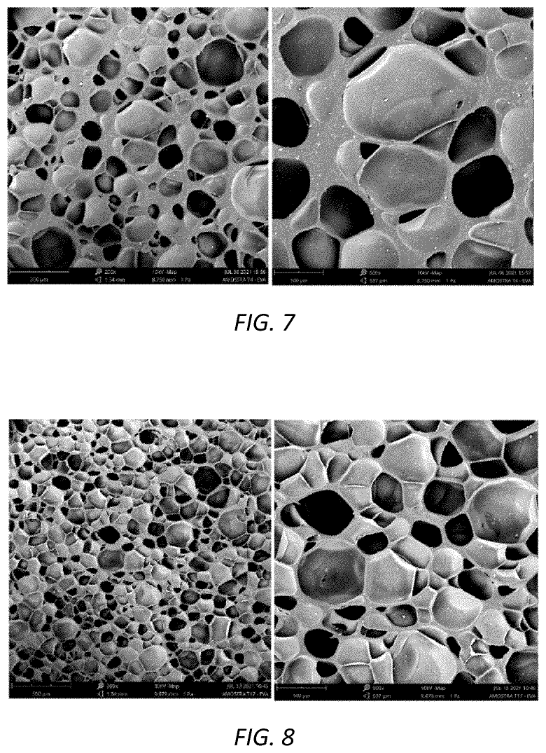

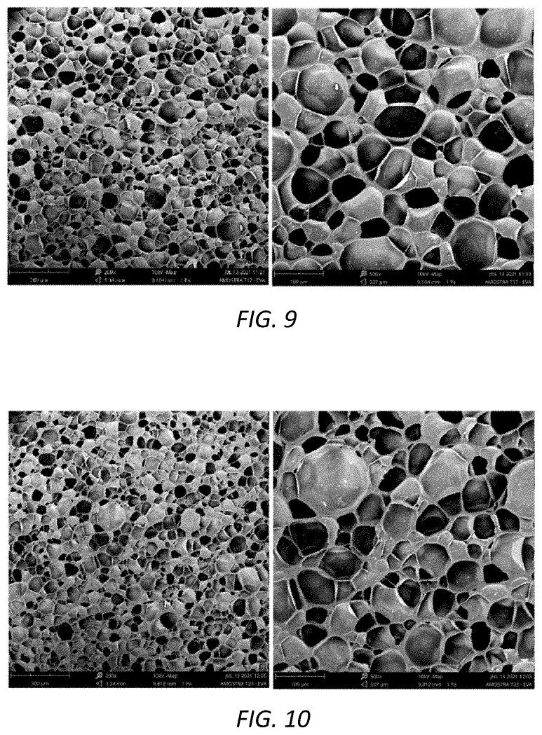

The design of experiments with base polymer DV001B (˜9 wt % VeoVa) led to the following results, available in Table 12. Testing conducted as described previously. The following ranges could be observed. FIGS. 5-10 show microstructures of the samples.
Expansion (hot)—From 137.5 to 199.5;
Expansion (after cooling)—From 130 to 177;
Hardness (Asker C): From 39 to 73;
Hardness (Shore 0): From 33.6 to 62.9;
Resilience: From 45 to 56%;
Compression set (50° C., 50% def, 6 h): From 37.7 to 53.7%;
Density: From 0.134 to 0.408 g/cm³;
Stress at break: From 1.2 to 3.6 MPa;
Strain at break: From 364 to 740%;
Tensile modulus @ 300%: 0.28 to 0.8 MPa;
Abrasion wear: From 78 to 495 mm³;
Average shrinkage (oven, 70° C., 1 h): From 3.9 to 7.2%.

TABLE 12

| | | | | | | Compression | | | | Tensile | | Shrink- |
|---|---|---|---|---|---|---|---|---|---|---|---|---|
| | Expansion | Expansion | | | | Set (50° C., | | Stress | Strain | modulus | Abrasion | age |
| Sam- | (hot) | (cold) | Hardness | Hardness | Resilience | 50%, 6 h) | Density | at break | at break | @ 300% | wear | (70° C., |
| ple | (%) | (%) | (Asker C) | (Shore O) | (%) | (%) | (g/cm³) | (MPa) | (%) | (MPa) | (mm³) | 1 h) |
| 1 | 153 | 140 | 64 | 53.1 | 45 | 49.6 | 0.316 | 2 ± 0.1 | 521 ± 20.5 | 0.56 | 123 | 4.6 |
| 2 | 187.5 | 172 | 40 | 34.4 | 53 | 51.7 | 0.168 | 1.2 ± 0.1 | 364 ± 10.7 | 0.38 | 495 | 5.3 |
| 3 | 139.5 | 131 | 68 | 59.4 | 45 | 53.7 | 0.387 | 2.1 ± 0.1 | 443 ± 47.7 | 0.66 | 96 | 7 |
| 4 | 180 | 163 | 51 | 41.1 | 54 | 39.5 | 0.204 | 1.7 | 429 ± 10.3 | 0.47 | 367 | 7.2 |
| 5 | 147.5 | 138 | 65 | 54.2 | 45 | 49.4 | 0.326 | 2.3 | 552 ± 19.9 | 0.59 | 109 | 5.4 |
| 6 | 199.5 | 177 | 39 | 33.6 | 54 | 48.2 | 0.164 | 1.9 ± 0.1 | 623 ± 16.1 | 0.28 | 420 | 4.7 |
| 7 | 137.5 | 130 | 71 | 61.2 | 45 | 47.2 | 0.408 | 3 ± 0.1 | 576 ± 20.1 | 0.75 | 95 | 7 |
| 8 | 174.5 | 163 | 52 | 41.9 | 54 | 38.8 | 0.204 | 1.8 ± 0.1 | 384 ± 9 | 0.54 | 340 | 5.6 |
| 9 | 151.5 | 140 | 65 | 55.4 | 48 | 45.8 | 0.323 | 3.2 ± 0.1 | 740 ± 28.2 | 0.54 | 138 | 4.2 |
| 10 | 184 | 170 | 45 | 37.2 | 53 | 47.2 | 0.172 | 3.1 ± 0.2 | 723 ± 55.7 | 0.54 | 432 | 3.9 |
| 11 | 139 | 131 | 73 | 62.9 | 51 | 45.3 | 0.404 | 3.6 ± 0.2 | 642 ± 13 | 0.80 | 78 | 6.4 |
| 12 | 170 | 161 | 55 | 43.8 | 56 | 37.7 | 0.210 | 2.2 ± 0.1 | 388 ± 25.4 | 0.61 | 265 | 6.6 |

### Example 6

Samples 1 to 4 were tested for dynamic properties, and results are displayed in Table 13.

TABLE 13

| Sample | 1 | 2 | 3 | 4 |
|---|---|---|---|---|
| Component | DV001A | DV001B | EVANCE | EVA |
| | | | VA5018ALS | HM728 |
| Expansion after | 55 | 55 | 54 | 54 |
| compression molding (%) | | | | |
| Density (g/cm³) | 0.257 | 0.263 | 0.300 | 0.277 |
| Hardness (Asker C) | 50 | 53 | 55 | 58 |
| Rebound resilience (%) | 54 | 51 | 52 | 52 |
| Compression set (6 h, | 44.7 | 47.3 | 47.1 | 46.2 |
| 50%, 50° C.) | | | | |
| Abrasion wear (5N) | 74 | 56 | 107 | 170 |
| (mm³) | | | | |

The average of deformation by dynamic compression results are exhibited in Table 14. It can be seen that samples made of DV001B (˜9 wt % of VeoVa) and EVA HM728 (2 and 4, respectively) presented the best performance, with the lowest deformation after 100,000 cycles.

TABLE 14

| | Deformation after | Deformation |
|---|---|---|
| Sample | 100,000 cycles (%) | after 24 h (%) |
| 1 | 31.1 | 19.9 |
| 2 | 23.9 | 14.1 |
| 3 | 42.1 | 31.0 |
| 4 | 24.2 | 17.4 |

Results for cushion properties, energy and factor, for 113 and 216 N and for both compression and release cycles of the test are displayed on Table 14. Sample 1 (DV001A) presented slightly higher cushion factors compared to other samples at both 113 and 216N in the compression cycle, and response very similar to sample 4 in the release cycle. Besides, sample 1 presented the lower hysteresis value, meaning that it presented the highest energy return during the release cycle, which matches the response observed for rebound resilience. Besides, it was found as the material with the lowest hardness. Samples 2 (DV001B) and 3 (EVANCE) presented similar hysteresis values—as well as close hardness and resilience; both outperforming sample 4 (HM728) (sample with higher hardness, but similar rebound resilience)—even though sample 4 presented overall similar cushion factors compared to other samples.

TABLE 14

| | Sample | 1 | 2 | 3 | 4 |
|---|---|---|---|---|---|
| Compression | Cushion energy 113N (CEw) (mJ) | 281 | 296 | 321 | 293 |
| | Cushion energy 216N (Cer) (mJ) | 472 | 495 | 522 | 495 |
| | Cushion factor 113N (CFw) | 5.1 | 4.83 | 4.9 | 4.9 |
| | Cushion factor 216N (CFr) | 5.85 | 5.5 | 5.75 | 5.55 |
| Decompression | Cushion energy 113N (CEw) (mJ) | 244 | 254 | 278 | 244 |
| | Cushion energy 216N (Cer) (mJ) | 377 | 424 | 418 | 367 |
| | Cushion factor 113N (CFw) | 5.9 | 5.65 | 5.65 | 5.9 |
| | Cushion factor 216N (CFr) | 7.3 | 6.45 | 7.2 | 7.5 |
| Hysteresis | 113N (mJ) | 37 | 42 | 43 | 49 |
| | 216N (mJ) | 95 | 71 | 104 | 128 |

### Example 7

The results of the tested formulations are exhibited in Tables 15 and 16. It is clear in samples 1 and 2, with 105% expansion, that despite some changes in density, DV001A presented lower hardness and slightly higher resilience. For the adjusted formulations 3 and 4, with an expansion of 95% (target for some applications, such as insoles), a very similar hardness and resilience were detected—despite the odd density result, that could be treated as experimental error.

TABLE 15

| Property | Standard | 1 | 2 | 3 | 4 |
|---|---|---|---|---|---|
| Expansion (%) | Internal method | 105 | 105 | 95 | 95 |
| Density | ISO | 0.143 | 0.133 | 0.244**** | 0.231**** |
| (g/cm³) | 2781:2018- | | | | |
| | Method A* | | | | |
| Hardness | NBR | 24 | 29 | 33 | 34 |
| Asker C | 14455:2015** | | | | |
| Rebound | DIN 53512** | 56 | 54 | 60 | 60 |
| resilience (%) | | | | | |
| Oven | Internal | 16.74 dir. A | 14.65 dir. A | 16.13 dir. A | 15.35 dir. A |
| shrinkage | method* | 17.55 dir. B | 14.43 dir. B | 15.41 dir. B | 14.7 dir. B |
| (70° C. 1 h) (%) | | | | | |

Samples were climatized for 24 h at 23 ± 2° C., 50 ± RU for all tests
* The fabric was removed prior testing.
** Test performed in the opposite side of the fabric.
*** Specimens die-cut and piled up to the desired thickness. Talc was used a lubricant for the test. The fabric was in contact with the test device walls.
**** Odd, unexpected values. Might be experimental error.

The results for formulations 5 to 10, all blends of an EVA (PN2021) and DV001B, despite changes in expansion and density (acceptable to a production environment), show a clear trend of decreasing hardness by incremental addition of DV001B (e.g. compare samples 6, 9 and 10), and also the increase of rebound resilience when increasing content of DV001B.

Shrinkage in oven at 70° C. for 1 h has slightly increased with the use of higher levels of DV001B (from 0.5 to 0.75%), however, changes in formulation led to acceptable levels, much lower than of the initial formulations, and it is not considered critical anymore. In terms of compression set, data display a slight trend of decrease, which indicate lower permanent via gas exit, or/and better viscoelastic recovery when adding DV001B. Interestingly, a “sharp” decrease from 14.6 to 12.1 happened from sample 7 to 8, when the major component of the polymer formulation changed from PN2021 to DV001B. Also, the difference between the measurements after 1 hour and 24 hours increase with higher DV001B content, since crosslinked polymers with more pronounced viscoelastic behavior can lead to deformation recovery.

TABLE 16

| Property | 5 | 6 | 7 | 8 | 9 | 10 |
|---|---|---|---|---|---|---|
| Expansion (%) | 100% | 92% | 96% | 95% | 90% | 90% |
| Density (g/cm³) | 0.12 | 0.14 | 0.12 | 0.13 | 0.14 | 0.14 |
| Hardness Shore A | 16 | 19 | 16 | 16 | 17 | 15 |
| Hardness Asker C | 32 | 38 | 32 | 32 | 34 | 30 |
| Rebound resilience | 40 | 43 | 46 | 43 | 47 | 47 |
| (%) (Insole) | | | | | | |
| Compression set | 33.7 | 29.5 | 37.1 | 41.8 | 35.9 | 40.7 |
| (22 h, 23° C., 25%. | | | | | | |
| Def. (%) (Insole)— | | | | | | |
| Measurement after 1 h | | | | | | |
| Compression set | 14.1 | 14.3 | 14.6 | 12.1 | —* | 12.1 |
| (22 h, 23° C., 25%. | | | | | | |
| Def. (%) (Insole)— | | | | | | |
| Measurement after 24 h | | | | | | |
| Oven shrinkage | 0.5 | 0.5 | 0.5 | 0.5 | 0.75 | 0.75 |
| (70° C., 1 h) (%) | | | | | | |

*Large standard deviation
— Data not reported

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A polymer composition, comprising:
a polymer produced from ethylene, one or more branched vinyl ester monomers, and optionally, vinyl acetate;
a foaming agent; and
a peroxide.

2. The polymer composition of claim 1, wherein the polymer produced from ethylene, one or more branched vinyl ester monomers, and optionally, vinyl acetate is present in an amount ranging from 20 to 100 phr; the foaming agent is present in an amount ranging from 0.1 to 15 phr; and the peroxide is present in an amount ranging from 0.1 to 10 phr; and where the polymer composition optionally comprises from 0 to 80 phr of a secondary foamable polymer.

3. The polymer composition of claim 1, wherein the one or more branched vinyl ester monomers have the general structure (II): 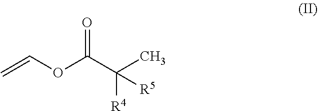
wherein R⁴ and R⁵ have a combined carbon number of 7.

4. The polymer composition of claim 1, wherein the polymer is a copolymer consisting of ethylene and the one or more branched vinyl ester.

5. The polymer composition of claim 1, wherein the polymer is a terpolymer consisting of ethylene, the one or more branched vinyl ester and vinyl acetate.

6. The polymer composition of claim 1, wherein the polymer has an ethylene content in an amount ranging from 50 to 99.9 wt %.

7. The polymer composition of claim 1, further comprising an ethylene vinyl acetate copolymer in an amount ranging from 0.1 to 80 phr.

8. The polymer composition of claim 7, wherein the ethylene vinyl acetate copolymer has a vinyl acetate content in an amount ranging from 0.01 to 50 wt %.

9. The polymer composition of claim 1, further comprising 0.1 to 5 phr of a foaming agent accelerator.

10. The polymer composition of claim 1, further comprising at least one filler or nanofiller in an amount ranging from 0.01 to 75 phr.

11. The polymer composition of claim 1, further comprising one or more elastomers.

12. The polymer composition of claim 1, wherein the polymer has a bio-based carbon content according to ASTM D6866-18 that ranges from of 1% to 100%.

13. The polymer composition of claim 1, wherein the composition is an expanded polymer composition.

14. The polymer composition of claim 1, wherein the polymer composition is a cured expanded polymer composition that exhibits a hardness ranging from 15 to 90 Asker C as determined by JIS K7312.

15. The polymer composition of claim 1, wherein the polymer composition is a cured expanded polymer composition that exhibits a hardness ranging from 20 to 90 Shore 0 as determined by ASTM D2240.

16. The polymer composition of claim 1, wherein the polymer composition is a cured expanded polymer composition that exhibits a density of 0.8 g/cm³ or less as determined by ASTM D792.

17. The polymer composition of claim 1, wherein the polymer composition is a cured expanded polymer composition that exhibits a resilience of at least 30% as determined by ASTM D2632.

18. The polymer composition of claim 1, wherein the polymer composition is a cured expanded polymer composition that exhibits an abrasion of 700 mm³ or less as determined by ISO 4649:2017 measured with a load of 5 N.

19. The polymer composition of claim 1, wherein the polymer composition is a cured expanded polymer composition having an expansion of 10% or more.

20. The polymer composition of claim 1, wherein the polymer composition is a cured expanded polymer composition that exhibits a shrinkage of 3% or less as determined by using the PFI method (PFI “Testing and Research Institute for the Shoe Manufacturing Industry” in Pirmesens-Germany) at 70° C., for 1 h.

21. The polymer composition of claim 1, wherein the polymer composition is a cured expanded polymer composition that exhibits a compression set of lower than 15% as determined by ASTM D395 (Method B, 23° C., 25% Strain, 22 hours)—measured after 24 hours.

22. The polymer composition of claim 1, wherein the polymer composition is a cured expanded polymer composition that exhibits a compression set of lower than 75% as determined by ASTM D395 (Method B, 50° C., 50% Strain, 6 hours).

23. The polymer composition of claim 1, wherein the polymer composition is a cured expanded polymer composition that exhibits a tear strength of at least 0.1 N/mm as determined by ASTM D624.

24. The polymer composition of claim 1, wherein the polymer composition is a cured expanded polymer composition that exhibits a bonding strength of at least 0.1 N/mm as determined by ABNT-NBR 10456.

25. An expanded article prepared from the polymer composition of claim 1.

26. The article of claim 25, wherein the article is selected from the group consisting of shoe soles, midsoles, outsoles, unisoles, insoles, monobloc sandals, flip flops, and sportive articles.

27. A method, comprising:
blending a polymer composition from a mixture comprising a polymer produced from ethylene, one or more branched vinyl ester monomers, and optionally, vinyl acetate; optionally a secondary foamable polymer; a foaming agent; and a peroxide.

28. The method of claim 27, wherein the polymer produced from ethylene, one or more branched vinyl ester monomers, and optionally, vinyl acetate is present in an amount ranging from 20 to 100 phr; the foaming agent is present in an amount ranging from 0.1 to 15 phr; the peroxide is present in an amount ranging from 0.1 to 10 phr; and the secondary foamable polymer is present in an amount ranging from 0 to 80 phr.

29. The method of any of claim 27, wherein blending comprises processing the mixture using a kneader, banbury mixer, mixing roller or twin screw extruder.

30. The method of claim 27, wherein the method further comprises:
curing and expanding the polymer composition.

31. The method of claim 30, wherein the expanding comprises compression or injection molding.
